(19) United States
(12) Patent Application Publication
(10) Pub. No.: US 2026/0041227 A1
(43) Pub. Date: Feb. 12, 2026

(54) CLEANING APPARATUS

(71) Applicant: Shenzhen Lute Jiacheng Supply chain Management Co., Ltd., Shenzhen (CN)

(72) Inventors: Caihu Jia, Shenzhen (CN); Hengwei Wei, Shenzhen (CN); Jun Wang, Shenzhen (CN); Jianru Li, Shenzhen (CN)

(21) Appl. No.: 19/361,019

(22) Filed: Oct. 17, 2025

(30) Foreign Application Priority Data
Oct. 18, 2024 (CN) 202422530260.1

(51) Int. Cl. A46B 13/04; A46B 13/00; F16H 1/06; F16H 57/02; F16H 57/021

(52) U.S. Cl. CPC A46B 13/04; A46B 13/001; F16H 1/06; F16H 57/021; A46B 2200/3006; F16H 2057/02034; F16H 2057/02073

(57) ABSTRACT

A cleaning apparatus including a housing, a brush body, a liquid storage member, a communication member, and a liquid discharge driving member. The brush body is disposed outside the housing and is provided with liquid discharge holes. The liquid storage member is connected to the housing and is in communication with the liquid discharge holes through the communication member. The liquid discharge driving member is connected to the communication member or the liquid storage member, and is used to drive the liquid in the liquid storage member to flow toward the brush body and be discharged from the liquid discharge holes of the brush body.

### CROSS-REFERENCE TO RELATED APPLICATIONS

The present application claims priority of Chinese Patent Application No. 202422530260.1, filed on Oct. 18, 2024, the entire contents of which are hereby incorporated by reference.

### TECHNICAL FIELD

The present disclosure relates to the technical field of cleaning products, in particular to a cleaning apparatus.

### BACKGROUND

A cleaning brush can effectively remove dirt from hard-to-reach area of the inner wall of a bottle. For example, a bottle brush used for cleaning baby bottles can ensure the cleanliness of the baby bottle. Existing cleaning brushes are mainly divided into two types: manual cleaning brushes and electric cleaning brushes. A manual cleaning brush requires users to manually pour cleaning solution onto the part to be cleaned before brushing, which is not convenient or intelligent. Under the second type, using a cleaning brush for dispensing liquid is relatively convenient and smart, but the liquid spray outlet of the existing electric cleaning brush is arranged on the main body of the machine, preventing the cleaning solution from entering the bottle alongside the brush head, which leads to poor cleaning effect and inconvenient use.

### SUMMARY

In view of the shortcomings of the prior art, the present disclosure provides a cleaning apparatus, which can discharge cleaning solution to the brush head, thus realize the effect of liquid discharge from the brush head, improve cleaning efficiency, and is convenient to use.

In order to achieve the above purpose, the present disclosure adopts the following technical scheme:

A cleaning apparatus including a housing, a brush body, a liquid storage member, a communication member, and a liquid discharge driving member. The brush body is disposed outside the housing and is provided with liquid discharge holes. The liquid storage member is connected to the housing and is in communication with the liquid discharge holes through the communication member. The liquid discharge driving member is connected to the communication member or the liquid storage member, and is used to drive the liquid in the liquid storage member to flow toward the brush body and be discharged from the liquid discharge holes of the brush body.

In one embodiment, the brush body includes a brush rod and brush bristles. The brush rod is provided with a liquid guiding cavity in communication with the at least one liquid discharge hole. The brush rod is connected to the communication member, and the liquid guiding cavity is in communication with the communication member. The brush bristles are connected to the brush rod. The liquid discharge holes are formed in the brush rod and/or the brush bristles.

In one embodiment, the communication member includes a catheter and a hollow rotating shaft. The hollow rotating shaft is rotatably connected to the housing and is provided with a liquid discharge channel. One end of the hollow rotating shaft is connected to the brush body, and the liquid discharge channel is in communication with the at least one liquid discharge hole. Another end of the hollow rotating shaft is in communication with the catheter, and the catheter is in communication with the liquid storage member. The liquid discharge driving member is connected to the catheter.

In one embodiment, the cleaning apparatus further includes a rotation driving member disposed in the housing. The rotation driving member has an output end that is connected to the hollow rotating shaft and is used to drive the hollow rotating shaft to rotate.

In one embodiment, the housing has a first central axis, the hollow rotating shaft has a second central axis, and the first central axis coincides with the second central axis.

In one embodiment, the rotation driving member includes a driving motor, a driving gear, and a transmission gear. The driving gear is connected to an output end of the driving motor. The transmission gear is connected to the hollow rotating shaft, and the transmission gear is meshed with the driving gear.

In one embodiment, the cleaning apparatus further includes a protective cover covering the outer periphery of the transmission gear. The protective cover is provided with a through hole used for the transmission gear to extend out or the driving gear to extend into. The protective cover includes a first cover plate and a second cover plate. The first cover plate and the second cover plate are respectively joined together from opposite sides of the transmission gear. One of the first cover plate and the second cover plate is provided with a slot, and the other one of the first cover plate and the second cover plate is provided with an insertion part. The insertion part is inserted into the slot.

In one embodiment, the communication member includes an adapter fixedly disposed in the housing. The adapter is provided with an assembly cavity and a connection port in communication with the assembly cavity. The connection port is in communication with the catheter. The hollow rotating shaft extends into the assembly cavity and is rotatably matched with the assembly cavity. The liquid discharge channel is in communication with the connection port.

In one embodiment, the liquid storage member is detachably connected to the housing.

In one embodiment, the cleaning apparatus further includes a sealing member, and the housing is provided with an extension hole. The communication member extends out of the extension hole to be connected to the brush body, and the sealing member is disposed between the communication member and the extension hole; or the brush body extends into the extension hole to be connected to the communication member, and the sealing member is disposed between the brush body and the extension hole.

The beneficial effects of the present disclosure are as follows: The embodiment of the present disclosure provides a cleaning apparatus, which includes a housing, a brush body, a liquid storage member, a communication member, and a liquid discharge driving member. The brush body is disposed outside the housing and is provided with at least one liquid discharge hole. The liquid storage member is connected to the housing and is in communication with the at least one liquid discharge hole through the communication member. The liquid discharge driving member is connected to the communication member or the liquid storage member, and is used to drive the liquid in the liquid storage member to flow toward the brush body and be discharged from the at least one liquid discharge hole of the brush body. Compared with the prior art, in the present disclosure, the brush rod is in communication with the liquid storage member through the communication member, so that the liquid inside the liquid storage member can be guided to the brush rod and discharged from the at least one liquid discharge hole of the brush rod. With such an arrangement, the cleaning solution can be introduced into a bottle very conveniently and simply, avoiding the cleaning solution flowing out of the bottle and reducing the waste of the cleaning solution. In addition, by arranging liquid discharge holes at different angles of the brush rod, the plurality of liquid discharge holes can guide the cleaning solution to various positions inside the bottle, thereby improving the cleaning efficiency and cleaning effect.

### BRIEF DESCRIPTION OF DRAWINGS

To illustrate the technical solutions more clearly in the present disclosure, a brief description of the accompanying drawing to be used in the description of the embodiments will be given below. The drawings described below are obviously just embodiment/embodiments of the present disclosure. For ordinary technicians in this field, other drawings can be obtained based on the drawing without doing creative work.

FIG. 1 schematically shows a structure of a cleaning apparatus according to an embodiment of the present disclosure;

FIG. 2 is a schematical cross-sectional view of a cleaning apparatus according to an embodiment of the present disclosure;

FIG. 3 is a schematical cross-sectional view of a communication member according to an embodiment of the present disclosure;

FIG. 4 schematically shows a structure of a communication member according to an embodiment of the present disclosure.

### REFERENCE NUMERALS

1. Housing; 11. Extension hole; 2. Brush body; 21. Liquid discharge hole; 22. Brush rod; 23. Brush bristle; 221. Liquid guiding cavity; 3. Liquid storage member; 4. Liquid discharge driving member; 5. Communication member; 51. Catheter; 52. Hollow rotating shaft; 53. Adapter; 521. Liquid discharge channel; 531. Assembly cavity; 532. Connection port; 6. Rotation driving member; 61. Driving motor; 62. Driving gear; 63. Transmission gear; 7. Protective cover; 71. Through hole; 72. First cover plate; 73. Second cover plate; 721. Insertion part; 731. Slot; 8. Sealing member.

### DESCRIPTION OF EMBODIMENTS

In the present disclosure, the terms “arrange”, “be provided with”, and “connect” should be understood in a broad sense. For example, they may refer to fixed connection, detachable connection, or integral structure; may refer to mechanical connection or electrical connection; may refer to direct connection, or indirect connection through an intermediate medium, or internal communication between two devices, components, or parts. For those of ordinary skill in the art, the specific meanings of the above terms in the present disclosure can be understood according to specific situations.

The terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “radial”, “circumferential”, etc. indicate orientations or positional relationships based on the orientations or positional relationships shown in the drawings, which are only for the convenience of describing the present application and simplifying the description, rather than indicating or implying that the referred device or element must have a specific orientation, be constructed and operated in a specific orientation, and thus cannot be understood as a limitation to the present application.

In addition, the terms “first” and “second” are only used for descriptive purposes, and cannot be understood as indicating or implying relative importance or implicitly indicating the number of the indicated technical features. Therefore, the features defined with “first” and “second” may explicitly or implicitly include at least one such feature. In the description of the present application, the meaning of “plurality” is at least two, such as two, three, etc., unless otherwise clearly and specifically defined.

Moreover, some of the above terms may not only be used to indicate orientations or positional relationships, but also may be used to indicate other meanings. For example, the term “upper” may also be used to indicate a certain attachment relationship or connection relationship in some cases. For those of ordinary skill in the art, the specific meanings of these terms in the present disclosure can be understood according to specific situations.

In order to make the purpose, technical scheme, and advantages of the present disclosure clearer, the present disclosure will be further described in detail below with reference to the accompanying drawings and embodiments. It should be understood that the specific embodiments described herein are only used to explain the present disclosure, and are not used to limit the present disclosure.

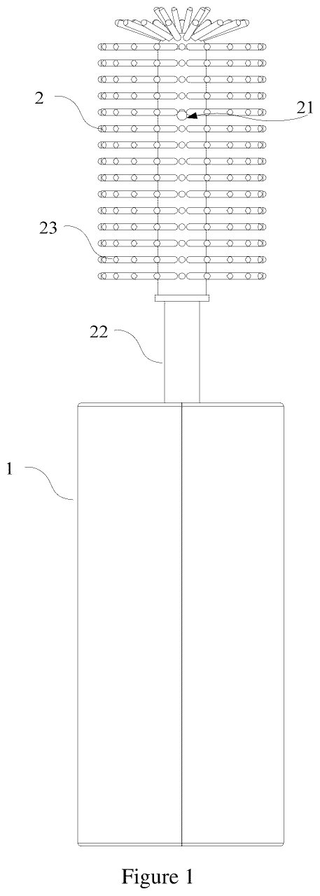

Referring to FIG. 1, an embodiment of the present disclosure provides a cleaning apparatus, which includes a housing 1, a brush body 2, a liquid storage member 3, a liquid discharge driving member 4, and a communication member 5. The brush body 2 is disposed outside the housing 1 and is provided with at least one liquid discharge hole 21. The liquid storage member 3 is connected to the housing 1 and is in communication with the at least one liquid discharge hole 21 through the communication member 5. The liquid discharge driving member 4 is connected to the communication member 5 or the liquid storage member 3, and is used to drive the liquid in the liquid storage member 3 to flow toward the brush body 2 and be discharged from the at least one liquid discharge hole 21 of the brush body 2.

In one embodiment, the cleaning apparatus can be used to clean products such as baby bottles and reagent bottles. Generally, the mouth of the bottle is small, making it difficult to introduce cleaning solution into the bottle accurately. Furthermore, the solution may not flow to the bottom of the bottle, leaving stubborn stains there are hard to clean, resulting in poor cleaning effect. Based on this, the cleaning apparatus of the present disclosure is provided with liquid discharge holes 21 on the brush body 2. When cleaning is needed, the brush body 2 can be extended into the bottle. Under the drive of the liquid discharge driving member 4, the cleaning solution stored in the liquid storage member 3 will flow through the communication member 5, the brush rod 22, and finally flow out of the liquid discharge holes 21 of the brush body 2 into the bottle. In this way, the cleaning solution can be effectively pumped into the bottle. When the brush body 2 rotates, the cleaning solution can flow to multiple positions in the bottle along with the brush body 2, so as to clean the inside of the bottle at multiple angles.

It should be noted that when no cleaning solution is needed for cleaning, the solution inside the liquid storage member 3 can be replaced with water, and then the water is sprayed into the bottle through the liquid discharge holes 21 on the brush body 2, so as to realize multiple cleaning modes.

Compared with the prior art, in the present disclosure, the brush body 2 is in communication with the liquid storage member 3 through the communication member 5, so that the liquid inside the liquid storage member 3 can be guided to the brush body 2 and discharged from the liquid discharge holes 21 of the brush body 2. With such an arrangement, the cleaning solution can be introduced into a bottle very conveniently and simply, avoiding the cleaning solution flowing out of the bottle and reducing the waste of the cleaning solution. In addition, by arranging the liquid discharge holes 21 at different angles of the brush body 2, the plurality of liquid discharge holes 21 can guide the cleaning solution to various positions inside the bottle, thereby improving the cleaning efficiency and cleaning effect.

It can be understood that the liquid discharge driving member 4 can adopt a structure such as a water pump.

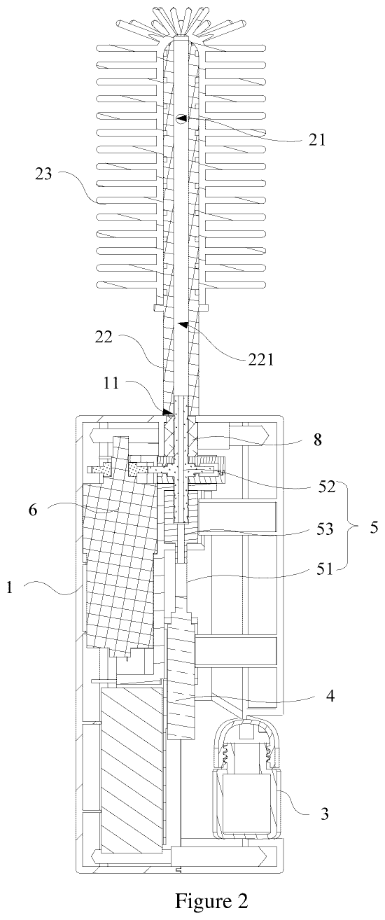

Referring to FIG. 2, the brush body 2 includes a brush rod 22 and brush bristles 23. The brush rod 22 is provided with a liquid guiding cavity 221 in communication with the liquid discharge holes 21. The brush rod 22 is connected to the communication member 5, and the liquid guiding cavity 221 is in communication with the communication member 5. The brush bristles 23 are connected to the brush rod 22. The liquid discharge holes 21 are defined on the brush rod 22 and/or the brush bristles 23. In this embodiment, the liquid discharge holes 21 are arranged on the side surface and/or the end part of the brush rod 22.

In one embodiment, the brush rod 22 is provided with a liquid guiding cavity 221. The liquid guiding cavity 221 is in communication with the liquid storage member 3 through the communication member 5, and is used to guide the liquid in the liquid storage member 3 to the liquid discharge holes 21. The liquid discharge holes 21 can be formed at any part of the brush rod 22. For example, the liquid discharge holes 21 are formed at the top of the brush rod 22, so that the cleaning solution can be conveniently guided to the bottom of the bottle. Alternatively, the liquid discharge holes 21 are formed in the circumferential direction of the brush rod 22, so that the cleaning solution can be conveniently guided to the body of the bottle. The brush rod 22 is connected with brush bristles 23, and the brush bristles 23 can be made of a material with certain flexibility. When the brush rod 22 is extended into the bottle, the brush bristles 23 can flexibly enter various complex-shaped parts inside the bottle, such as the connection between the bottle body and the bottle neck, the concave part at the bottom of the bottle, etc., and perform all-round brushing on these parts to ensure that every corner can be cleaned.

It should be noted that the brush bristles 23 can also be made of a relatively hard material, and the liquid discharge holes 21 can also be formed in the brush bristles 23, that is, the brush bristles 23 can be in the shape of hollow tubes. The present disclosure does not limit this.

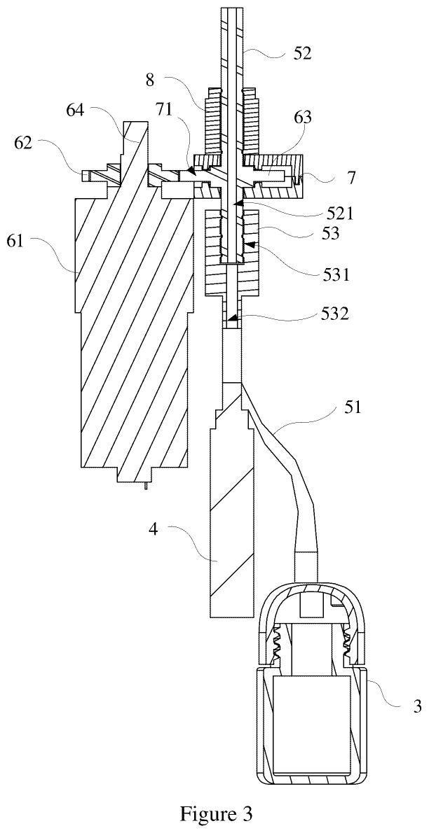

Referring to FIG. 2 and FIG. 3, the communication member 5 includes a catheter 51 and a hollow rotating shaft 52. The hollow rotating shaft 52 is rotatably assembled to the housing 1 and is provided with a liquid discharge channel 521. One end of the hollow rotating shaft 52 is connected to the brush body 2, and the liquid discharge channel 521 is in communication with the liquid discharge holes 21. The other end of the hollow rotating shaft 52 is connected to the catheter 51, and the catheter 51 is in communication with the liquid storage member 3. The liquid discharge driving member 4 is connected to the catheter 51.

In one embodiment, the communication member 5 is mainly used to communicate the brush rod 22 with the liquid storage member 3. The communication member 5 includes a hollow rotating shaft 52, and the hollow rotating shaft 52 is provided with a liquid discharge channel 521 in communication with the liquid guiding cavity 221 of the brush rod 22. One end of the catheter 51 is in communication with the liquid discharge channel 521, and the other end is in communication with the liquid storage member 3. The liquid discharge driving member 4 is connected to the catheter 51 to provide power for the flow of liquid. In other embodiments, referring to FIG. 3, the liquid discharge driving member 4 can be connected to the liquid storage member 3 via the catheter 51 to provide power for the flow of liquid. With such an arrangement, on the one hand, the hollow rotating shaft 52 can communicate the liquid guiding cavity 221 with the liquid storage member 3, so as to realize the function of guiding the cleaning solution to the liquid discharge holes 21. On the other hand, the hollow rotating shaft 52 is fixedly connected to the brush rod 22 and rotatably connected to the housing 1, so that the hollow rotating shaft 52 can drive the brush rod 22 to rotate relative to the housing 1. When the brush rod 22 rotates, the brush bristles 23 can more flexibly contact various parts inside the bottle, and the inner wall, bottom, bottle neck, and other parts of the bottle can be easily cleaned without frequently adjusting the angle and position of the hand. This greatly saves the cleaning time and improves the cleaning efficiency.

Referring to FIG. 2 and FIG. 3, the cleaning apparatus further includes a rotation driving member 6. The rotation driving member 6 is disposed in the housing 1, and an output end 64 of the rotation driving member 6 is connected to the hollow rotating shaft 52 and is used to drive the hollow rotating shaft 52 to rotate.

In one embodiment, the present disclosure adopts an electric way to drive the brush rod 22 to rotate. The rotation driving member 6 is connected to the hollow rotating shaft 52. When cleaning is needed, the rotation driving member 6 is started, and the rotation driving member 6 drives the hollow rotating shaft 52 to rotate, so that the hollow rotating shaft 52 drives the brush rod 22 to rotate. As a result, under the user's operation, the brush bristles 23 act on the surface of the bottle at different angles and with different forces, so as to better remove stubborn stains and dirt conveniently.

It can be understood that the rotation driving member 6 can adopt a structure such as a motor.

Referring to FIG. 2 again, the housing 1 has a first central axis, the hollow rotating shaft 52 has a second central axis, and the first central axis coincides with the second central axis. In one embodiment, the hollow rotating shaft 52 is centrally arranged in the housing 1, that is, the hollow rotating shaft 52 is symmetrically arranged with respect to the first central axis. In this way, when the hollow rotating shaft 52 rotates, the force applied to each part inside the housing 1 is more uniform, and the overall weight distribution of the housing 1 is more uniform, so as to avoid heavier weight on one side and affect the holding feel. In addition, the brush rod 22 connected to the hollow rotating shaft 52 can also be centrally arranged, which further balances the weight of each part of the apparatus as a whole and improves the holding comfort.

Referring to FIG. 3, the rotation driving member 6 can include a driving motor 61, a driving gear 62, and a transmission gear 63. The driving gear 62 is connected to an output end 64 of the driving motor 61. The transmission gear 63 is connected to the hollow rotating shaft 52, and the transmission gear 63 is meshed with the driving gear 62. The transmission gear 63 can be fixedly sleeved or integrally sleeved on the outer side of the hollow rotating shaft 52.

In one embodiment, the rotation driving member 6 is connected to the hollow rotating shaft 52 through a transmission component. Specifically, the rotation driving member 6 includes a driving motor 61, and the driving motor 61 and the hollow rotating shaft 52 are sequentially arranged along the radial direction of the housing 1. The liquid discharge driving member 4 can be sequentially arranged with the hollow rotating shaft 52 along the axial direction of the housing 1, so as to more reasonably arrange the installation space.

In addition, through the meshing of the driving gear 62 and the transmission gear 63, the driving force of the driving motor 61 is transmitted to the hollow rotating shaft 52, which not only realizes the rotation function of the hollow rotating shaft 52, but also reasonably arranges the installation space inside the housing 1 and improves the use comfort.

Referring to FIG. 3, the cleaning apparatus may further include a protective cover 7. The protective cover 7 covers the outer periphery of the transmission gear 63 or the driving gear 62, and is provided with a through hole 71. The through hole 71 is used for the transmission gear 63 to extend out or the driving gear 62 to extend into, so that the driving gear 62 is meshed with the transmission gear 63. In one embodiment, the protective cover 7 is used to protect the transmission gear 63 or the driving gear 62, and isolate the transmission gear 63 or the driving gear 62 from other components inside the housing 1, so as to prevent the gear from colliding with other components inside the housing 1 and being damaged during rotation. At the same time, the protective cover 7 can also prevent external impurities from entering the gear, so as to ensure that the driving motor 61 can drive the hollow rotating shaft 52 to work normally.

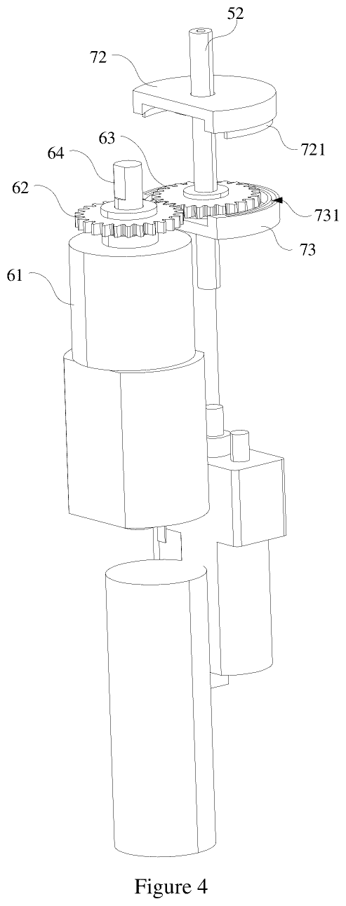

Referring to FIG. 4, the above-mentioned protective cover 7 can include a first cover plate 72 and a second cover plate 73. The first cover plate 72 and the second cover plate 73 are assembled from opposite sides of the transmission gear 63.

In one embodiment, in order to facilitate the installation and disassembly of the protective cover 7, the protective cover 7 includes a first cover plate 72 and a second cover plate 73, and the first cover plate 72 and the second cover plate 73 are detachably connected. The first cover plate 72 and the second cover plate 73 can be assembled from the left and right sides or the upper and lower sides of the transmission gear 63 to cover the transmission gear 63. Both the first cover plate 72 and the second cover plate 73 are provided with avoidance holes for avoiding the hollow rotating shaft 52. With such an arrangement, the protective cover 7 can be installed without removing the transmission gear 63 from the hollow rotating shaft 52, and the protective cover 7 is simple and convenient to install and disassemble.

One of the first cover plate 72 and the second cover plate 73 is provided with a slot 731, and the other one of the first cover plate 72 and the second cover plate 73 is provided with an insertion part 721. The insertion part 721 is inserted into the slot 731.

In one embodiment, the first cover plate 72 and the second cover plate 73 can be connected in an inserting way. For example, the first cover plate 72 is provided with an insertion part 721, and the second cover plate 73 is provided with a slot 731. When the first cover plate 72 and the second cover plate 73 are assembled, the insertion part 721 is inserted into the slot 731, so that the first cover plate 72 and the second cover plate 73 are connected.

It can be understood that in some other embodiments, the first cover plate 72 and the second cover plate 73 can also be connected in other ways, such as snap connection, bolt connection, etc. The present disclosure does not limit this.

Referring to FIG. 3, the communication member 5 may further include an adapter 53. The adapter 53 is disposed in the housing 1 and is provided with an assembly cavity 531 and a connection port 532 in communication with the assembly cavity 531. The connection port 532 is connected to the catheter 51. The hollow rotating shaft 52 extends into the assembly cavity 531 and is rotatably matched with the assembly cavity 531. The liquid discharge channel 521 is in communication with the connection port 532.

In one embodiment, in order to realize the rotation and liquid guiding functions of the hollow rotating shaft 52, the present disclosure is provided with an adapter 53. The adapter 53 is provided with an assembly cavity 531 and a connection port 532 which are in communication with each other. The connection port 532 is in communication with the liquid storage member 3 through the catheter 51, so that the liquid in the liquid storage member 3 can be guided to the connection port 532. The hollow rotating shaft 52 extends into the assembly cavity 531, and the liquid discharge channel 521 of the hollow rotating shaft 52 communicates the liquid guiding cavity 221 of the brush rod 22 with the connection port 532, so that the liquid in the liquid storage member 3 is guided to the brush rod 22 through the connection port 532, and the function of discharging the cleaning solution from the liquid discharge holes 21 is realized. The assembly cavity 531 is cylindrical and is adapted to the hollow rotating shaft 52. The hollow rotating shaft 52 is inserted into the assembly cavity 531 and is in communication with the connection port 532. A sealing ring can be arranged between the hollow rotating shaft 52 and the assembly cavity 531. The connection port 532 can be in a tubular shape, and the catheter 51 can be sleeved on the connection port 532.

Since the hollow rotating shaft 52 is rotatably matched with the assembly cavity 531 and the liquid discharge channel 521 is always in communication with the connection port 532 during rotation, the function of the hollow rotating shaft 52 driving the brush rod 22 to rotate and the function of the hollow rotating shaft 52 guiding the cleaning solution to the brush rod 22 are both realized.

Referring to FIGS. 1-3, the liquid storage member 3 is detachably connected to the housing 1. In one embodiment, the liquid storage member 3 and the housing 1 can be detachably connected in ways such as threaded connection, snap connection, embedded connection, etc., so that the liquid storage member 3 can be taken out to add cleaning solution or replace with different liquids.

Referring to FIG. 2, the cleaning apparatus can further include a sealing member 8, and the housing 1 is provided with an extension hole 11. The front end of the communication member 5 (the hollow rotating shaft 52) extends out of the extension hole 11 to be connected to the brush body 2, and the sealing member 8 is disposed between the communication member 5 and the extension hole 11; or the brush body 2 extends into the extension hole 11 to be connected to the communication member 5, and the sealing member 8 is disposed between the brush body 2 and the extension hole 11.

In one embodiment, in order to prevent liquid from entering the housing 1 from the connection between the housing 1 and the brush rod 22, the present disclosure is provided with a sealing member 8. The hollow rotating shaft 52 can extend out of the extension hole 11 and extend into the liquid guiding cavity 221 of the brush rod 22, so that the liquid can directly enter the liquid guiding cavity 221 from the liquid discharge channel 521. The sealing member 8 is arranged between the hollow rotating shaft 52 and the housing 1 to seal the gap between the hollow rotating shaft 52 and the extension hole 11, so as to prevent liquid from seeping into the housing 1.

Alternatively, the brush rod 22 extends into the housing 1 from the extension hole 11 to be connected to the hollow rotating shaft 52. In this case, there is a risk of leakage between the brush rod 22 and the extension hole 11. Therefore, the sealing member 8 can be arranged between the brush rod 22 and the housing 1 to seal the gap between the brush rod 22 and the extension hole 11, so as to prevent liquid from seeping into the housing 1.

Different from the prior art, the embodiment of the present disclosure provides a cleaning apparatus, which includes a housing 1, a brush body 2, a liquid storage member 3, a liquid discharge driving member 4, and a communication member 5. The brush body 2 is disposed outside the housing 1 and is provided with liquid discharge holes 21. The liquid storage member 3 is connected to the housing 1 and is in communication with the liquid discharge holes 21 through the communication member 5. The liquid discharge driving member 4 is connected to the communication member 5 or the liquid storage member 3, and is used to drive the liquid in the liquid storage member 3 to flow toward the brush body 2 and be discharged from the liquid discharge holes 21 of the brush body 2. Compared with the prior art, in the present disclosure, the brush rod 22 is connected to the liquid storage member 3 through the communication member 5, so that the liquid inside the liquid storage member 3 can be guided to the brush rod 22 and discharged from the liquid discharge holes 21 of the brush rod 22. With such an arrangement, the cleaning solution can be introduced into a bottle very conveniently and simply, avoiding the cleaning solution flowing out of the bottle and reducing the waste of the cleaning solution. In addition, by arranging the liquid discharge holes 21 at different angles of the brush rod 22, the plurality of liquid discharge holes 21 can guide the cleaning solution to various positions inside the bottle, thereby improving the cleaning efficiency and cleaning effect.

The above are only specific implementation modes of the present application. For those of ordinary skill in the art, several improvements and modifications can be made without departing from the principle of the present application, and these improvements and modifications should also be regarded as the protection scope of the present application.

What is claimed is:

1. A cleaning apparatus, comprising:
a housing (1);
a brush body (2) disposed outside the housing (1), the brush body (2) comprising at least one liquid discharge hole (21);
a communication member (5);
a liquid storage member (3) connected to the housing (1) and being in communication with the at least one liquid discharge hole (21) through the communication member (5);
a liquid discharge driving member (4) connected to the communication member (5) or the liquid storage member (3).

2. The cleaning apparatus according to claim 1, wherein the brush body (2) comprises a brush rod (22) and brush bristles (23), the brush rod (22) comprises a liquid guiding cavity (221) in communication with the at least one liquid discharge hole (21), the brush rod (22) is connected to the communication member (5) and the liquid guiding cavity (221) is in communication with the communication member (5), and the brush bristles (23) are connected to the brush rod (22); wherein the at least one liquid discharge hole (21) is formed in the brush rod (22) and/or the brush bristles (23).

3. The cleaning apparatus according to claim 1, wherein the communication member (5) comprises a catheter (51) and a hollow rotating shaft (52), the hollow rotating shaft (52) is rotatably connected to the housing (1) and comprises a liquid discharge channel (521), one end of the hollow rotating shaft (52) is fixedly connected to the brush body (2) and the liquid discharge channel (521) is in communication with the at least one liquid discharge hole (21), another end of the hollow rotating shaft (52) is in communication with the catheter (51), the catheter (51) is in communication with the liquid storage member (3), and the liquid discharge driving member (4) is connected to the catheter (51).

4. The cleaning apparatus according to claim 3, wherein the cleaning apparatus further comprises a rotation driving member (6) disposed in the housing (1), the rotation driving member (6) comprises an output end that is connected to the hollow rotating shaft (52) and is used to drive the hollow rotating shaft (52) to rotate.

5. The cleaning apparatus according to claim 3, wherein the housing (1) defines a first central axis, the hollow rotating shaft (52) defines a second central axis, and the first central axis coincides with the second central axis.

6. The cleaning apparatus according to claim 4, wherein the rotation driving member (6) comprises a driving motor (61), a driving gear (62), and a transmission gear (63), the driving gear (62) is connected to the output end of the driving motor (61), the transmission gear (63) is connected to the hollow rotating shaft (52), and the transmission gear (63) is meshed with the driving gear (62).

7. The cleaning apparatus according to claim 6, wherein the cleaning apparatus further comprises a protective cover (7)covering the transmission gear (63), the protective cover (7) comprises a through hole (71) configured for the transmission gear (63) to extend out or the driving gear (62) to extend into; the protective cover (7) comprises a first cover plate (72) and a second cover plate (73), the first cover plate (72) and the second cover plate (73) are respectively joined together from opposite sides of the transmission gear (63), and the hollow rotating shaft (52) penetrates the first cover plate (72) and the second cover plate (73); one of the first cover plate (72) and the second cover plate (73) comprises a slot (731), and the other one of the first cover plate (72) and the second cover plate (73) comprises an insertion part (721), and the insertion part (721) is inserted into the slot (731).

8. The cleaning apparatus according to claim 3, wherein the communication member (5) comprises an adapter (53) fixedly disposed in the housing (1), the adapter (53) comprises an assembly cavity (531) and a connection port (532) in communication with the assembly cavity (531), the connection port (532) is in communication with the catheter (51), the hollow rotating shaft (52) extends into the assembly cavity (531) and is rotatably matched with the assembly cavity (531), and the liquid discharge channel (521) is in communication with the connection port (532).

9. The cleaning apparatus according to claim 1, wherein the liquid storage member (3) is detachably connected to the housing (1).

10. The cleaning apparatus according to claim 1, wherein the cleaning apparatus further comprises a sealing member (8), and the housing (1) comprises an extension hole (11); the communication member (5) extends out of the extension hole (11) to be connected to the brush body (2), and the sealing member (8) is arranged between the communication member (5) and the extension hole (11); or the brush body (2) extends into the extension hole (11) to be connected to the communication member (5), and the sealing member (8) is arranged between the brush body (2) and the extension hole (11).

11. The cleaning apparatus according to claim 4, wherein the brush rod (22) is connected to the rotating shaft (52) so as to be driven to rotate by the rotation driving member (6).

12. The cleaning apparatus according to claim 6, wherein the driving motor (61) and the hollow rotating shaft (52) are sequentially arranged along a radial direction of the housing (1).

13. The cleaning apparatus according to claim 12, wherein liquid discharge driving member (4) are sequentially arranged with the hollow rotating shaft (52) along an axial direction of the housing (1).
